(19) United States
(12) Patent Application Publication
(10) Pub. No.: US 2005/0177479 A1
(43) Pub. Date: Aug. 11, 2005

(54) System and method for calculating low-level codes for items in a bill of material

(76) Inventor: Hung Shan Wei, Tu-Chen (TW)

Correspondence Address: WEI TE CHUNG;FOXCONN INTERNATIONAL, INC., 1650 MEMOREX DRIVE, SANTA CLARA, CA, 95050, US

(21) Appl. No.: 10/737,462

(22) Filed: Dec. 15, 2003

(30) Foreign Application Priority Data
Dec. 13, 2002 (TW) 91136039

(51) Int. Cl. G06F 17/60

(52) U.S. Cl. 705/34

(57) ABSTRACT

A system for calculating low-level codes (LLCs) for items in a bill of material (BOM) includes a database (301) for storing BOMs; a data obtaining unit (303) for obtaining BOMs from the database; an LLC setting unit (305) for setting LLCs for items; and a data analyzing unit (307) for determining whether an item exists in designated columns in a BOM. A related method for calculating LLCs for items in a BOM includes the steps of: (a) setting an initial value of a variable N as zero, and setting all LLCs for items in the BOM as vacant; (b) reading a first item in the BOM; (c) determining whether the item exists in a child item column of the BOM; (d) setting the LLC of the item as zero if the item does not exist in the child item column; and (e) setting LLCs for other items in the BOM.

### BACKGROUND OF THE INVENTION

1. Field of the Invention

The present invention relates to Material Requirement Planning (MRP) systems and methods, and especially to an MRP system and method in which low-level codes (LLCs) for items in a bill of material (BOM) can be easily calculated.

2. Background of the Invention

A part list is usually needed in order to manufacture a product. A main function of a conventional part list is to explain what components or materials are required to manufacture or assembly an end product, and their respective usage quantities. Since Material Requirement Planning (MRP) was developed in the early 1970s, the part list has gradually evolved into the so-called Bill of Material (BOM). A BOM provides more functions, and has a more complicated structure resembling a tree structure. A BOM lists not only all components that make up an end product, but also subassemblies or semi-finished articles. Customarily, a BOM comprises a plurality of part items. Each part item has a level code, which relates to a relative position of the part item in the BOM. Multiple-use component items usually have several level codes, because they may appear in different levels of a single product structure. In these circumstances, a so-called low-level code (LLC) is used, which means the highest level number at which a multiple-use component item is used across a same BOM. Generally speaking, a finished product (end item) is at the top of a product structure or a BOM, and it is assigned an LLC of zero. The lower the level at which a component item appears in a BOM, the larger number of its LLC is.

However, most MRP systems utilized in modern corporations do not provide the function of automatically calculating LLCs for part items. Users of MRP software need to calculate LLCs in a BOM manually. Those manual operations significantly reduce the efficiency of BOMs in MRP systems. Accordingly, what is needed is a computer-implemented system and method, in which LLCs for all part items in a BOM can be easily calculated.

### SUMMARY OF THE INVENTION

A main objective of the present invention is to provide a low-level code (LLC) calculation system and method, which can assist users in calculating LLCs for items in a BOM.

To achieve the above objective, a system for calculating LLCs for items in a BOM comprises: a database for storing BOMs and product structures; a data obtaining unit for obtaining BOMs and product structures from the database; an LLC setting unit for setting LLCs for items in a BOM; and a data analyzing unit for determining whether all items in the BOM have been read in a particular procedural loop cycle, and for checking whether a particular item exists in designated columns in the BOM.

Further, the present invention provides a method for calculating LLCs for items in a BOM. The method comprises the steps of: (a) setting an initial value of a variable N as zero, and setting all LLCs for items in the BOM as vacant; (b) reading a first item in the BOM; (c) determining whether the item exists in a child item column in the BOM; (d) setting the LLC of the item as zero if the item does not exist in the child item column; and (e) setting LLCs for other items in the BOM.

Other objects, advantages and novel features of the present invention will be drawn from the following detailed description of the preferred embodiment and preferred method of the present invention with the attached drawings, in which:

### BRIEF DESCRIPTION OF THE DRAWINGS

FIG. 1 is an illustration of the assignment of LLCs to manufactured product structures or bills of material;

FIG. 2 is an illustration of main columns in a bill of material;

FIG. 3 is a schematic diagram of main software units of a system for calculating LLCs for items in a bill of material in accordance with the preferred embodiment of the present invention; and

FIG. 4A and FIG. 4B in combination are a flowchart illustrating a preferred method for calculating LLCs for items in a bill of material according to the present invention.

### DETAILED DESCRIPTION OF THE INVENTION

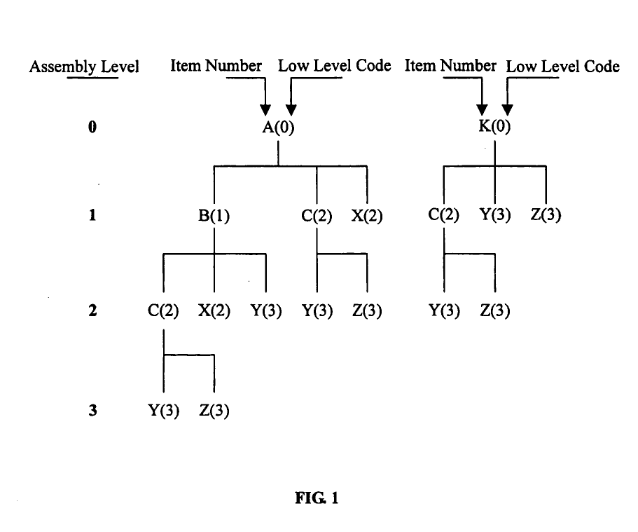

FIG. 1 is an illustration of the assignment of low-level codes (LLCs) to manufactured product structures or bills of material (BOMs). A manufactured product structure can be considered as a tree structure. At the top of trees are end items which are assigned LLCs of zeros. In FIG. 1, items A and K are both end products; therefore the LLCs for these items are zeros (shown in parentheses). It is to be understood that the terms “end products,” “items” and “part items” are used interchangeably throughout this description. All component items are assigned LLCs which are numerically higher than the LLC assigned to the higher level assembly or end item. For a multiple-use component item, such as item C, X, Y or Z in the product structure of item A, the highest possible numerical value of the item is assigned as the LLC of the item. This represents the lowest level at which a multiple-use component item is used within the entire product structure.

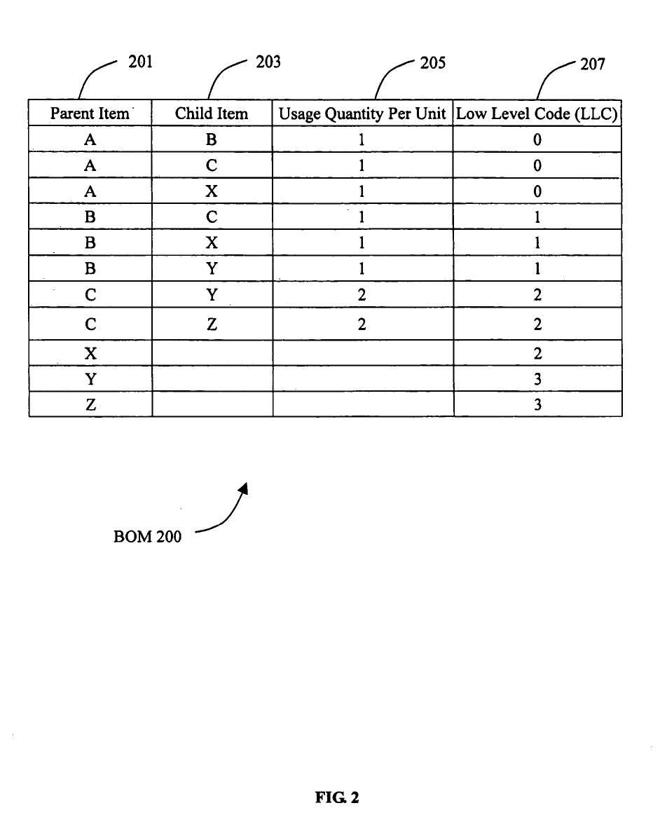

FIG. 2 is an illustration of main columns in a BOM (Bill of Material) 200, which is related to the product structure of item A of FIG. 1. There are four columns shown in the BOM 200: parent item 201, child item 203, usage quantity per unit 205, and LLC (low-level code) 207. The child item 203 column lists part items that are used in assembling or manufacturing respective parent items listed in the parent item 201 column. Each part item in the child item 203 column has an assembly level, wherein the assembly level of a corresponding end product is zero. Multiple-use items may have several assembly levels, and therefore appear in different locations in the BOM 200. The usage quantity per unit 205 represents a quantity of each child item in the child item 203 column required in assembling or manufacturing the corresponding parent item in the parent item 201 column. The LLC 207 lists LLCs for the parent items in the parent item 201 column.

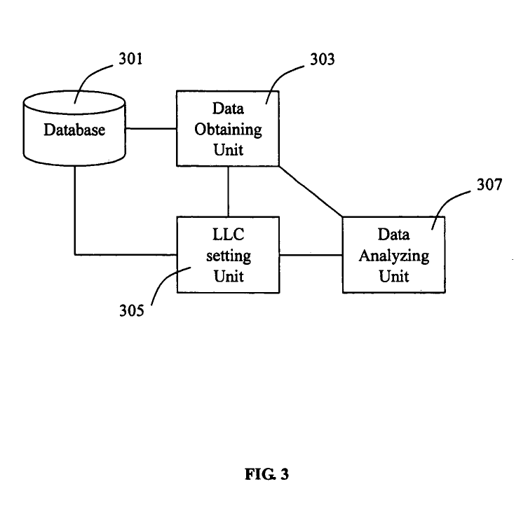

FIG. 3 is a schematic diagram of main software units of a system for calculating LLCs for items in a BOM in accordance with the preferred embodiment of the present invention. The system comprises a database 301, a data obtaining unit 303, an LLC setting unit 305, and a data analyzing unit 307. The database 301 stores BOMs or product structures used in Manufacturing Resource Planning (MRPII). The data obtaining unit 303 retrieves BOMs and product structures from the database 301, in order to obtain information on items in the BOMs and product structures. The LLC setting unit 305 is provided for initializing and setting LLCs for all items in a BOM. The data analyzing unit 307 is for determining whether all items in the BOM have been read in a particular procedural loop cycle, and for checking whether a particular item exists in designated columns in the BOM.

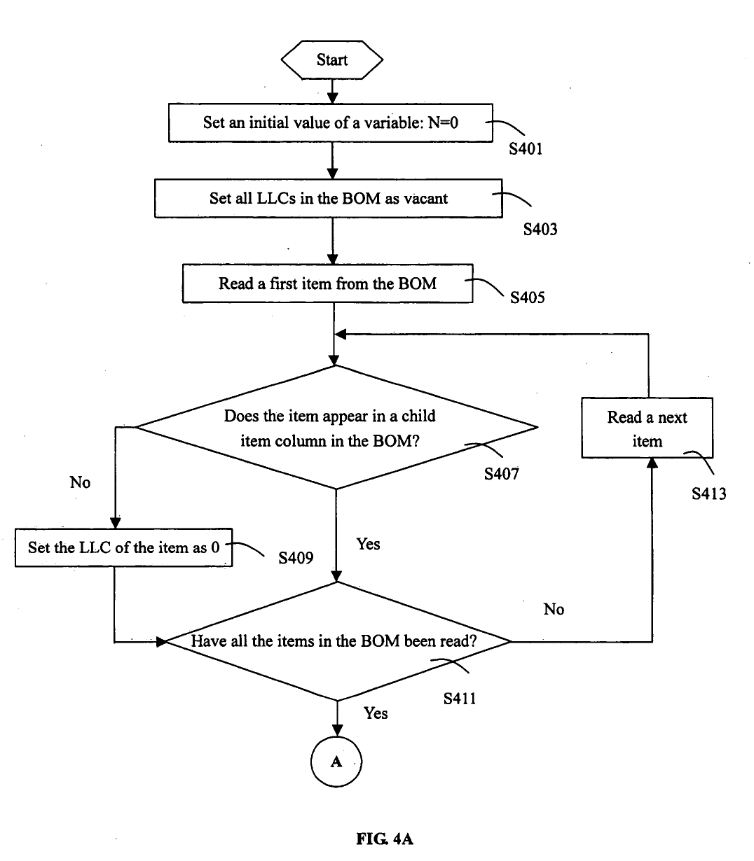

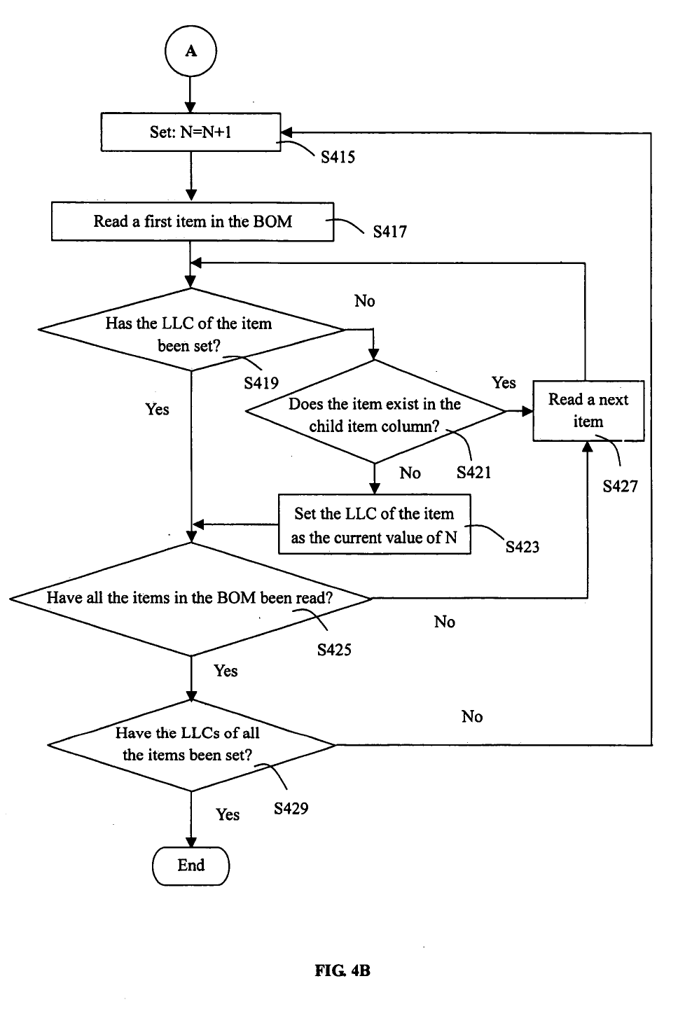

FIG. 4A and FIG. 4B in combination are a flowchart illustrating a preferred method for calculating LLCs for items in the BOM 200. In this method, an LLC of an end product in a product structure is first set, and LLCs for other child items in the product structure are then determined. First, in step S401, a variable N is provided as a cyclical variable in order to determine LLCs for items in loop cycles of the method. The initial value of the variable N is set as zero. In step S403, the LLCs for all the items in the BOM 200 are set vacant by the LLC setting unit 305. In step S405, the data obtaining unit 303 reads a first item in the parent item 201 column. In the preferred embodiment, item A is read in this step. In step S407, the data analyzing unit 307 determines whether the item exists in the child item 203 column. If the item does not exist in the child item 203 column, in step S409, the LLC of the item is set as zero. If the item exists in the child item 203 column, in step S411, the data analyzing unit 307 checks to see whether all the items in the BOM 200 have been read. If all the items in the BOM 200 have been read, the procedure goes directly to step S415 described below. If there is any item in the BOM 200 that has not been read, in step S413, the data obtaining unit 303 reads a next item in the parent item 201 column, and the procedure returns to step S407 described above. Since the child item 203 column of the BOM 200 does not comprise item A, the LLC of item A is set as zero, indicating that item A is an end product. When item B is read, because it appears in the child item 203 column, the data obtaining unit 303 proceeds to read the next item, namely item C. Thus, the LLC of item B remains vacant in this cycle.

When all the items in the BOM 200 have been read, in step S415, the value of the variable N is increased by one. Consequently, the current value of the variable N becomes zero plus one, namely one. In step S417, the data obtaining unit 303 reads a first item in the BOM 200 (i.e., item A). In step S419, the data analyzing unit 307 determines whether the LLC of the item has been set. If the LLC has been set, the procedure goes directly to step S425 described below. If the LLC has not been set, in step 421, the data analyzing unit 307 determines whether the item exists in the child item 203 column, and if so, whether the assembly level of the child item is numerically higher than the current value of the variable N (i.e., one). If the item exists in the child item 203 column, and its assembly level is higher than one, the procedure proceeds to step S427 described below. If the item does not exist in the child item 203 column, or if its assembly level is not higher than one, in step S423, the LLC of the item is set as the current value of N (i.e., one). In step S425, the data analyzing unit 307 checks to see whether all the items in the BOM have been read. If there are any items in the BOM 200 that have not been read, in step S427, the data obtaining unit 303 reads a next item from the BOM 200, and the procedure returns to step S419. If all the items in the BOM 200 have been read, in step S429, the data analyzing unit 307 determines whether LLCs for all the items in the BOM 200 have been set. If LLCs for any items have not been set, the procedure returns to step S415 described above, with the current value of the variable N being increased by one. The above-described procedures are repeated as necessary until all the LLCs for the items in the BOM 200 are set. If and when LLCs for all the items in the BOM 200 have been set, the procedure is ended.

Although the present invention has been specifically described on the basis of a preferred embodiment and preferred method, the invention is not to be construed as being limited thereto. Various changes or modifications may be made to said embodiment and method without departing from the scope and spirit of the invention.

1. A system for calculating low-level codes (LLCs) for items in a bill of material (BOM), the system comprising:
a database for storing BOMs and product structures;
a data obtaining unit for obtaining BOMs and product structures from the database;
an LLC setting unit for setting LLCs for items in a BOM; and
a data analyzing unit for determining whether all items in the BOM have been read in a particular procedural loop cycle, and for checking whether a particular item exists in designated columns in the BOM.

2. The system according to claim 1, wherein the LLC setting unit is also for setting all the LLCs in the BOM as vacant before calculation of the LLCs.

3. The system according to claim 1, wherein the LLC setting unit is also for setting an initial value of a variable N as 0.

4. The system according to claim 1, wherein the data analyzing unit is also for determining whether the LLCs for all the items in the BOM are vacant.

5. A computer-based method for calculating low-level codes (LLCs) for items in a bill of material (BOM), the method comprising the steps of:
setting an initial value of a variable N as zero, and setting all LLCs for items in the BOM as vacant;
reading a first item in the BOM;
determining whether the item exists in a child item column in the BOM;
setting the LLC of the item as zero if the item does not exist in the child item column; and
setting the LLCs for other items in the BOM.

6. The method according to claim 5, wherein the step of setting the LLCs for other items in the BOM comprises the steps of:
adding one to the value of the variable N;
reading a first item in the BOM;
determining whether the LLC of the item has been set;
checking whether the item exists in a child item column if the LLC of the item has not been set;
setting the LLC of the item as the current value of N if the item does not exist in the child item column;
checking whether all the items in the BOM have been read; and
determining whether the LLCs for all the items have been set.

7. The method according to claim 6, further comprising the step of reading a next item and returning to the step of determining whether the LLC of the item has been set, if the item exists in the child item column.

8. The method according to claim 6, further comprising the step of reading a next item and returning to the step of determining whether the LLC of the item has been set, if all the items in the BOM have not been read.

9. The method according to claim 6, further comprising the step of returning the procedure to the step of adding one to the value of the variable of N, if the LLCs for all the items have not been set.

10. A method of setting low-level codes (LLCs) for multiple items in a bill off material (BOM) comprising steps of:
(a) setting the initial value of said LLCs as zero and checking very item to record the corresponding ones if satisfies; and
(b) setting the LLCs with a value by adding one to zero and going through the rest ones not recorded; and
(c) repeating step (b) until all items are categorized.
